(19) United States
(12) Patent Application Publication
(10) Pub. No.: US 2013/0283581 A1
(43) Pub. Date: Oct. 31, 2013

(54) SEALANT REMOVAL TOOL

(71) Applicant: Malcolm Burr, Hampshire (GB)

(72) Inventor: Malcolm Burr, Hampshire (GB)

(21) Appl. No.: 13/660,600

(22) Filed: Oct. 25, 2012

(30) Foreign Application Priority Data
Oct. 25, 2011 (GB) GB1118377.9

(51) Int. Cl. B25B 27/14

(52) U.S. Cl. CPC B25B 27/14
USPC 29/235

(57) ABSTRACT

A sealant removal tool for removing a sealant plug from the nozzle of a sealant cartridge, the tool comprising a handle, a stem depending from the handle operative to apply a torque to the stem in use, the stem having a tip distal from the stem and being provided with an external screw thread along at least part of its length, the thread tapering inwardly from the handle towards the tip, the handle and stem being arranged such that the tip of the stem can be inserted into the sealant plug in the sealant cartridge nozzle and torque applied to the stem via the handle to drive the thread into the sealant plug, the handle being arranged to enable a user of the tool to subsequently apply a tensile force to the stem via the handle to remove the sealant plug from the nozzle, when a sufficient part of the thread has engaged the sealant plug.

The present invention relates to a sealant removal tool for removing a plug of sealant from the nozzle of a sealant cartridge.

It is common in the building and DIY trades to apply sealant from a sealant cartridge. Typically a conical nozzle is provided on the end of the cartridge through which sealant is dispensed. The cartridge may sometimes have deformable walls that can be squeezed to force the sealant through the nozzle or, more commonly, may be used in a sealant cartridge gun that comprises a plunger that moves the end of the sealant cartridge to force sealant through the nozzle.

In any event, sealant is retained in the nozzle after use, and even if a cap is applied to the end of the nozzle, the retained sealant typically dries, at least partially, inside the nozzle to form a plug that blocks the nozzle and resists dispensing of further sealant at a later date. It can be possible to dig out the sealant plug using a screw driver or the like, but this is difficult and time consuming. Likewise it is often easier to simply dispose of the nozzle and sealant plug, and use a new nozzle. However, it is often the case that a new nozzle is not available at the time.

It is therefore a frustrating and time consuming problem of how to remove the sealant plug from the nozzle of a sealant cartridge.

By ‘sealant’ we mean any material that can be dispensed from a cartridge through a nozzle. We therefore include, for example, interior and exterior silicon sealant, frame sealant, decorator's caulk, filler, and adhesive, including adhesive of the instant grab type.

According to a first aspect of the invention there is provided a sealant removal tool for removing a sealant plug from the nozzle of a sealant cartridge, the tool comprising a stem depending from a handle operative to apply a torque to the stem in use, the stem being provided with an external screw thread along at least part of its length, the thread tapering inwardly from the handle towards a distal tip of the stem, that is, the external diameter of the thread decreasing towards the tip of the stem, the handle and stem being arranged such that the tip of the stem can be inserted into the sealant plug in the sealant cartridge nozzle and torque applied to the stem via the handle to drive the thread into the sealant plug, the handle being arranged to enable the user of the tool to subsequently apply a tensile force to the stem via the handle to remove the sealant plug from the nozzle, when a sufficient part of the thread has engaged the sealant plug.

Preferably the tip of the stem is not threaded, that is, the thread terminates part way down the stem.

Preferably the thread terminates at the handle, that is, there is no exposed part of the stem between the thread and the handle.

Preferably the handle extends radially outwardly from the stem, to provide an enhanced torque in use to the stem. Most preferably the handle and stem are arranged in ‘T’ shaped configuration.

The stem may taper radially inwardly from the handle towards the stem tip.

The stem may be of constant diameter along its length.

The stem may be of stepped diameter, that is, the stem comprises at least a first portion of one diameter, and at least a second portion of a reduced diameter. More than two stepped portions may be provided.

The stem may comprise multiple stepped portions and a portion of varying diameter along its length. At least one of the stepped portions may be of varying diameter.

The pitch of the thread may vary towards the tip of the stem. The pitch of the thread may therefore increase or decrease towards the tip of the stem.

The depth of the thread may decrease towards the tip of the stem.

A protective sheath may be provided which received the stem when not in use. The upper end of the sheath may engage the top of the stem, or part of the handle, to retain the sheath on the stem.

The handle and stem may be integrally formed so as to comprise a single component. Alternatively the handle and stem may be separate components.

Other aspects of the present invention may include any combination of the features or limitations referred to herein.

The present invention may be carried into practice in various ways, but embodiments will now be described by way of example only with reference to the accompanying drawings in which:

FIG. 1 is a perspective view of a sealant removal tool in accordance with the present invention;

FIG. 2 is a side view of the tool of FIG. 1;

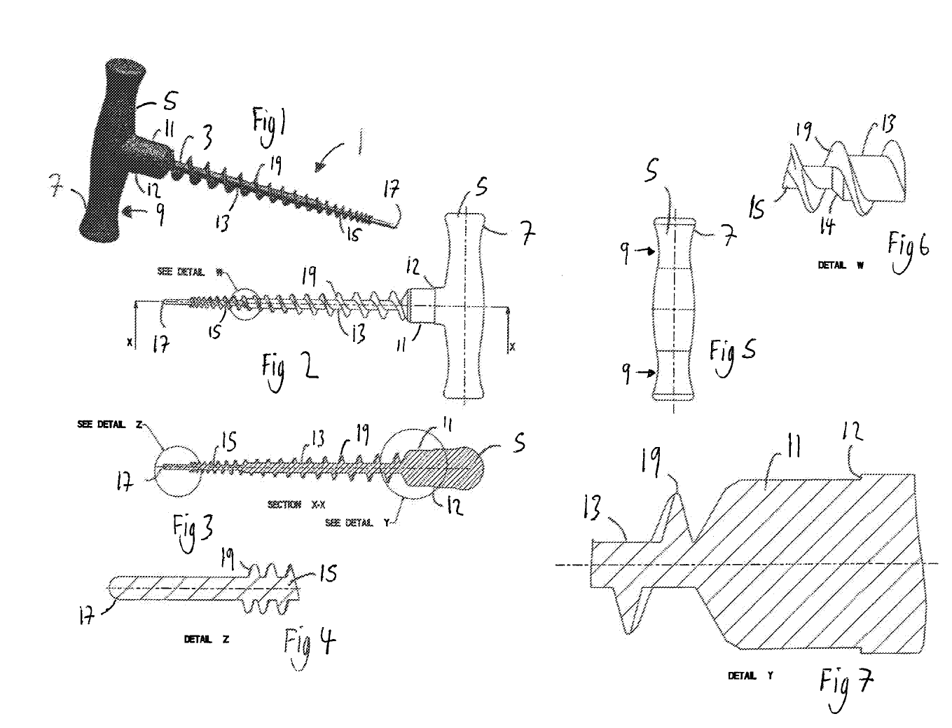

FIG. 3 is a sectional view taken on line X-X of FIG. 2;

FIG. 4 is an enlarged side view of detail Z of FIG. 3;

FIG. 5 is a view from the top of the tool of FIGS. 1 to 4;

FIG. 6 is an enlarged side view of detail W of FIG. 2

FIG. 7 is an enlarged side view of detail Y of FIG. 3

FIG. 8 is a perspective view of another sealant removal tool in accordance with the present invention;

FIG. 9 is a side view of the tool of FIG. 8;

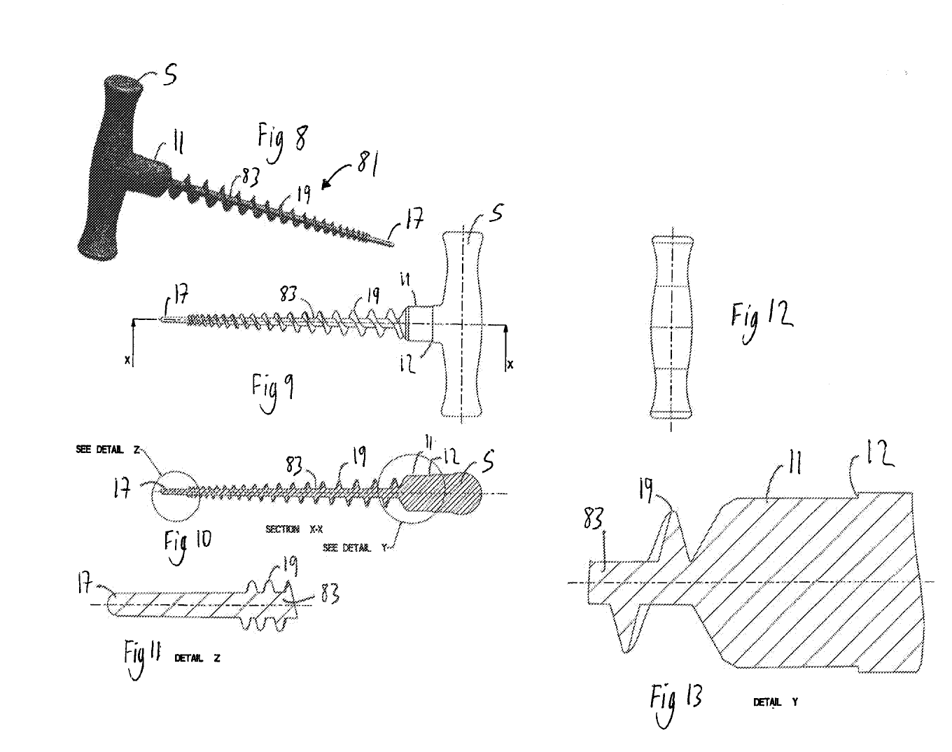

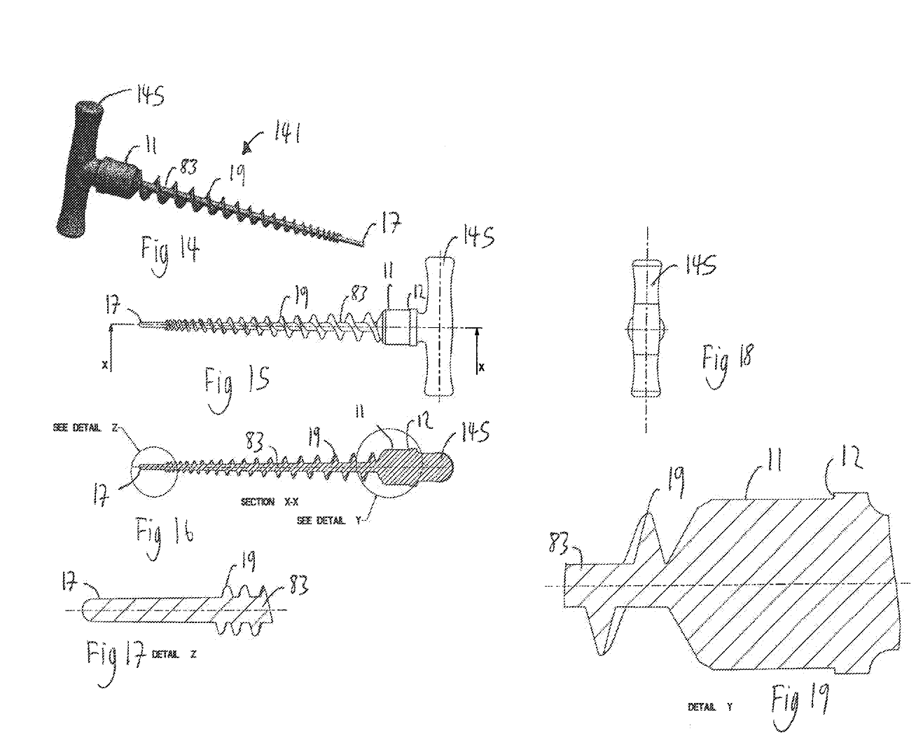

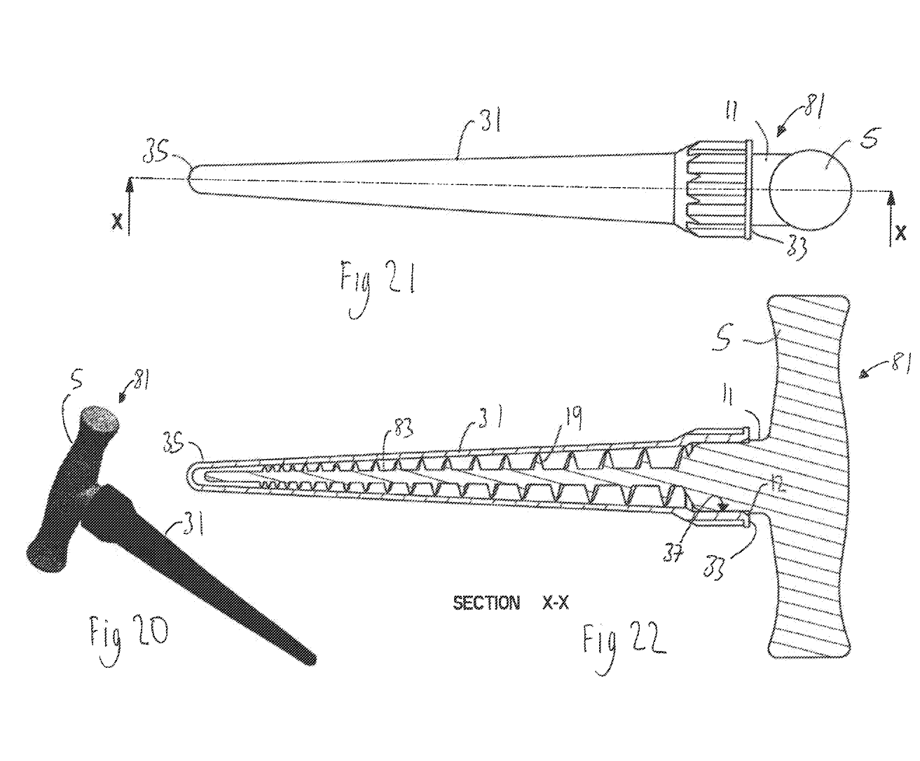

FIG. 10 is a sectional view taken on line X-X of FIG. 9;

FIG. 11 is an enlarged side view of detail Z of FIG. 10;

FIG. 12 is a view from the top of the tool of FIGS. 8 to 11;

FIG. 13 is an enlarged side view of detail Y of FIG. 10

FIG. 14 is a perspective view of a further sealant removal tool in accordance with the present invention;

FIG. 15 is a side view of the tool of FIG. 14;

FIG. 16 is a sectional view taken on line X-X of FIG. 15;

FIG. 17 is an enlarged side view of detail Z of FIG. 14;

FIG. 18 is a view from the top of the tool of FIGS. 14 to 17;

FIG. 19 is an enlarged side view of detail Y of FIG. 16;

FIG. 20 is a perspective view of the tool of FIGS. 8 to 13 with a protective sheath;

FIG. 21 is a side view corresponding to FIG. 20;

FIG. 22 is a sectional view taken on line X-X of FIG. 21;

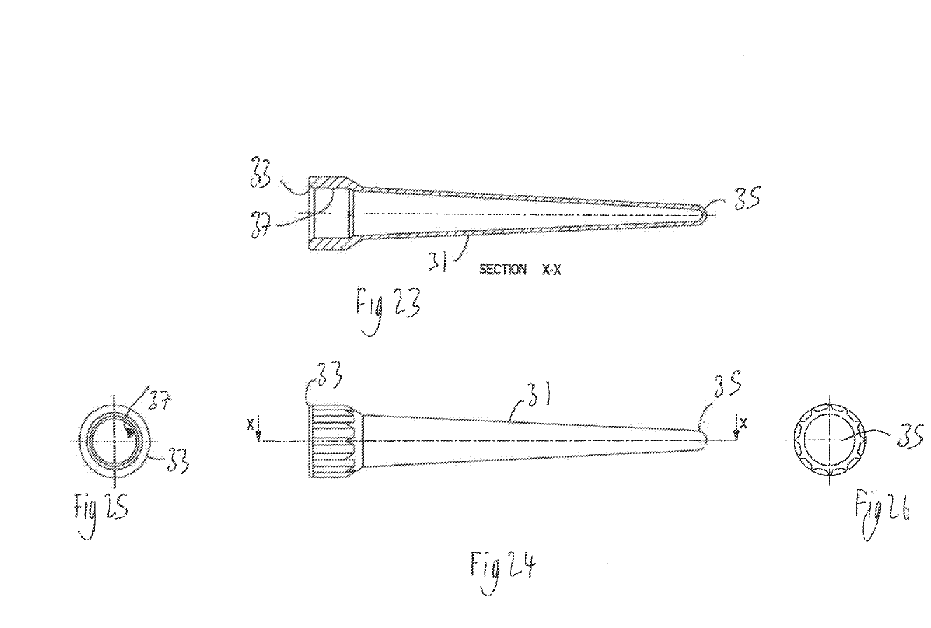

FIG. 23 is a sectional side view of the sheath of FIGS. 20 to 22;

FIG. 24 is a side view of the sheath of FIG. 23;

FIG. 25 is a view of one end of the sheath of FIGS. 23 and 24; and

FIG. 26 is a view of the other end of the sheath of FIGS. 23 to 25.

Referring initially to FIGS. 1 to 7, a sealant removal tool 1 comprises a generally cylindrical stem 3 depending from an elongate handle 5, the handle 5 and stem 3 being arranged in ‘T’ shaped configuration with the handle 5 extending radially outwardly from the stem 3.

The handle 5 may be of any suitable material or combination of materials such as a plastics, metal, wooden or carbon fibre material, and comprises an elongate grip portion 7 defining finger recesses 9, and a boss 11. A circumferential ridge 12 is defined on the boss 11.

The upper end of the stem 3 is mounted on the boss 11 of the handle 3, and this may be by inserting the upper end of the stem 3 into the boss 11. Alternatively the upper end of the stem 3 may comprise a cylindrical socket that receives the boss 11.

In this embodiment the stem 3 is stepped, that is, it defines an upper portion 13 of a first, constant diameter along its length, and a lower portion 15 of a second, reduced, constant diameter along its length. The reduced diameter portion 15 terminates in an elongate, round ended tip 17. The intersection between the two portions 13, 15 is tapered 14.

A screw thread 19 is provided along the length of the stem 3 and extends from the boss 11 of the handle 5 towards the tip 17, terminating a small distance from the tip 17. The thread 19 tapers radially inwardly from the handle 5 towards the tip 17 of the stem 3, that is, the external diameter of the thread 19 narrows towards the tip 17. The pitch of the thread 19 also decreases from the handle 5 to the tip 17, that is, the number of threads per axial distance, increases from the handle 5 to the tip 17. The depth of thread, that is, the distance between the outer diameter of the thread 19, and the diameter of the stem 3 itself, also decreases from the handle 5 towards the tip 17.

The handle 5 and stem 3 are thus arranged such that the tip 17 of the stem 3 can be inserted into a sealant plug in a sealant cartridge nozzle and torque applied to the stem 3 via the handle 5. This, combined with axial pressure applied via the handle 5 into the plug, drives the thread 19 into the sealant plug. Further rotation drives the thread 19 further into the plug, the taper of the thread 19 generally matching the taper of the nozzle in which the plug is stuck. The further the tool 1 is inserted into the plug and nozzle, the more of the material of the plug is engaged by the thread 19.

Once sufficient plug material is engaged, the handle 5 enables the user of the tool 1 to apply a tensile force to the stem 3 to remove the sealant plug from the nozzle. This tensile force may be applied simply by pulling the handle 5, or by rotating the handle 5 and stem 3, or by a combination of pulling and rotation. Sufficient force needs to be applied to break any adhesion between the outer surface of the plug material with the inner surface of the nozzle. In some cases part of the nozzle may be threaded, and in particular, may be threaded so as to be screwed onto the end of the sealant cartridge. If this thread extends up the nozzle, the sealant plug may dry around the thread. In this instance, the plug must be rotated within the nozzle to unscrew the plug from the nozzle threads.

Sometimes heating or cooling the nozzle down can help with the removal of the plug (as the materials have varying coefficient of thermal expansion).

Typically, partly because the plug tends to dry relatively solidly, and partly because the thread 19 engages the material of the plug at multiple regions along the plug's axial length, the plug can be pulled entirely from the nozzle, in one piece, thus clearing the nozzle in a single movement for reuse. However, sometimes multiple attempts might be required, the plug being removed in multiple pieces.

Referring to FIGS. 8 to 13 a modified sealant removal tool 81 comprises common features with the tool 1 of FIGS. 1 to 7, like features being given like references.

In this example, the tool 81 comprises a modified stem 83 which is not stepped but which tapers radially inwardly along its length from the handle 5 to the tip 17, that is, the diameter of the tip 17 reduces from the handle 5 to the tip 17. The variable pitch, variable depth thread 19 extends along the length of the modified stem 83, terminating a small space from the tip 17.

Referring to FIGS. 14 to 19 a further modified sealant removal tool 141 comprises common features with the modified tool 81 of FIGS. 8 to 13, like features being given like references.

In this example, the tool 141 comprises a modified handle 145 which is smaller than the handle 5 of the tools 1, 81.

Referring in particular to FIG. 20 onwards, a sheath 31 is provided to receive any of the stems 3, 83, of the tools 1, 81, 141 described above during storage or transportation of the tools 1, 81, 141.

The sheath 31 is of generally conical form, having a wider open end 33, and a closed narrower end 35. The wider open end 33 defines an internal face 37 dimensioned to snugly receive the boss 11 of handle 5, the upper margin of the wider open end 33 abutting the circumferential ridge 12 extending around the boss 11. The engagement of the boss 11 with the internal face 11 retains the sheath 31 on the tool 1, 81, 141 with the stem 3 and thread 19 safely contained within the sheath 31. This engagement may be a snap-fit or screw type engagement for example.

The stem, thread, and handle of any of the tools 1, 81, 141 may be formed from any suitable material or combination of materials. Such materials may include metal and plastics materials for example.

The stem, thread and handle may be formed integrally or with the handle as a separate component from the stem and thread. In the latter case, the stem and thread may be secured to the handle by inserting the upper end of the stem 3 into a bore formed in the boss of the handle. The upper end of the stem 3 may be retained by frictional engagement between the handle and stem materials, or via a thread formed on the upper end of the stem for example. The stem may be glued to the handle.

The handle may be of any form necessary to apply the required torque to the thread to drive the thread into the plug of sealant, and then to enable the user to grip the handle and pull the plug of sealant from the nozzle. Different sizes of handles may be provided as required to enable the requisite torque and tensile force to be applied. The handle may be elongate and generally cylindrical or oblong and arranged in ‘T’ shaped configuration with the stem 3, in accordance with the Figures. Alternatively the handle may be arranged with its longitudinal axis aligned with that of the stem, rather like a screwdriver handle for example. In that instance the handle may be of bulbous form.

The screw thread on the stem may of course vary as required to ensure that there is sufficient thread material to engage the plug material to enable the plug to be pulled from the nozzle. Thus the pitch and thread depth may vary as required, and need not be of variable pitch and/or variable depth as described above.

Having illustrated and described the principles of my invention with reference to a number of exemplary embodiments, it should be apparent to those of ordinary skill in the art that these embodiments may be modified in arrangement and detail without departing from the inventive principles disclosed herein. I claim as my invention all such embodiments that fall within the scope of the following claims.

1. A sealant removal tool for removing a sealant plug from the nozzle of a sealant cartridge, the tool comprising a handle, a stem depending from the handle operative to apply a torque to the stem in use, the stem having a tip distal from the stem and being provided with an external screw thread along at least part of its length, the thread tapering inwardly from the handle towards the tip, the handle and stem being arranged such that the tip of the stem can be inserted into the sealant plug in the sealant cartridge nozzle and torque applied to the stem via the handle to drive the thread into the sealant plug, the handle being arranged to enable a user of the tool to subsequently apply a tensile force to the stem via the handle to remove the sealant plug from the nozzle, when a sufficient part of the thread has engaged the sealant plug.

2. A tool according to claim 1 wherein the thread has an external diameter which decreases towards the tip of the stem.

3. A tool according to claim 1 wherein the stem has a tip which is not threaded.

4. A tool according to claim 1 wherein the thread terminates at the handle.

5. A tool according to claim 1 wherein the handle extends radially outwardly from the stem.

6. A tool according claim 1 wherein the handle and stem are arranged in a ‘T’ shaped configuration.

7. A tool according to claim 1 wherein the stem tapers radially inwardly from the handle towards the stem tip.

8. A tool according to claim 1 wherein the stem is of constant diameter along its length.

9. A tool according claim 1 wherein the stem is of stepped diameter, whereby the stem comprises at least a first portion of one diameter, and at least a second portion of a reduced diameter.

10. A tool according to claim 1 wherein the stem comprises multiple stepped portions and a portion of varying diameter along its length.

11. A tool according to claim 1 wherein the thread has a pitch which varies towards the tip of the stem.

12. A tool according to claim 11 wherein the thread has a depth which decreases towards the tip of the stem.

13. A tool according to claim 1 wherein a protective sheath is provided which is arranged to receive the stem when not in use.

14. A tool according to claim 13 wherein the sheath has an upper end which engages at least one of the stem and the handle, to retain the sheath on the stem.

15. A tool according to claim 1 wherein the handle and stem are integrally formed so as to comprise a single component.
